(19) United States
(12) Patent Application Publication
(10) Pub. No.: US 2011/0263276 A1
(43) Pub. Date: Oct. 27, 2011

(54) Method and System to Control Actions Based on Global Positioning System

(75) Inventors: Jerrold M. Heyman, Research Triangle Park, NC (US); Kenton R. Milligan, Rochester, MN (US); Michael L. Nelson, Research Triangle Park, NC (US); Antonio N. Pirraglia, Poughkeepsie, NY (US); Andrew G. Tonkin, Research Triangle Park, NC (US)

(73) Assignee: INTERNATIONAL BUSINESS MACHINES CORPORATION, Armonk, NY (US)

(21) Appl. No.: 12/767,153

(22) Filed: Apr. 26, 2010

(51) Int. Cl. H04W 24/00

(52) U.S. Cl. 455/456.3

(57) ABSTRACT

A method and system for restricting operation of at least one function of a communication device based upon the physical location of the device. Global position coordinates are leveraged to ascertain the location of the device and to restrict functionality of the device. One or more alternative solutions are presented as a substitute for the restricted functionality.

### BACKGROUND

1. Technical Field

The present invention relates to a method and system for controlling functions of an electronic communication device. More specifically, the method and system related to dynamic management of a portable communication device based upon geographic location of the device and its associated functionality.

2. Description of the Prior Art

In recent years, mobile telephone technology has evolved. More recently, we have witnessed the advent of the smart phone. The term smart phone is generally employed to characterize a wireless telephone set with special computer-enabled features not previously associated with telephones. In addition to functioning as an ordinary telephone, a smart phone may include one or more of the following features and/or functions: wireless electronic mail, internet access, personal information management, local area network connectivity, etc. Accordingly, based upon the functions outlined above, the smart phone technology allows a user to employ multiple functions of the device independent of the user's physical location.

However, certain functions of the smart phone device may not be appropriate or authorized depending on the situation and/or environment. More specifically, the smart phone device may be brought into a private environment and as such, there may be one or more restrictions on usage of the smart phone or specific functions supported by the smart phone in this private environment. It is known that not all persons abide by requested and/or required restrictions of a smart phone device. Accordingly, there is a need for a solution that detects and prohibits usage of the restricted functions in the private environment.

### SUMMARY OF THE INVENTION

A method, system, and article to control functionality of a wireless communication device is disclosed.

In one aspect, a method is provided for controlling a wireless communication device. Global position coordinates of the device are determined in response to activation of a function of the device. These coordinates are communicated to a provider in communication with the device, and are compared with coordinates retained in storage. One or more alternative services are offered to replace the activated function of the device in response to the coordinates matching the data in storage, and at the same time operation of the activated function are restricted.

In another aspect, a system is provided to control functionality of a wireless communication device. A global positioning transponder is incorporated within the device and is employed to determine global position coordinates of the device in response to activation of at least one function of the device. A communication manager is provided to communicate the device coordinates to a provider in communication with the device. In addition, a comparison manager is provided local to a server and managed by the provider. The comparison manager is provided to compare the coordinates with data retained in storage media. A service manager offers alternative services supported by the device in response to a match of the coordinates to the data. At the same time, operation of the at least one function is restricted.

In yet another aspect, an article is provided to communicate with a wireless communication device. A computer readable data storage medium is provided together with instructions in the medium to control at least one function of the communication device. More specifically, instructions are provided to determine global position coordinates of the device responsive to activation of at least one function of the device. Instructions are provided to communicate the coordinates of the device to a provider in communication with the device. Following receipt of the coordinates, instructions are provided to compare the coordinates with data in storage media in communication with the provider. Instructions are also provided to offer services alternative to services provided by the at least one function of the device responsive to the coordinates matching the data. At the same time, operation of the at least one function is restricted.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a flowchart illustrating a process for restricting certain functions of a communication device based upon the user location.

FIG. 2 is a flow chart illustration a process for leveraging data gathered from a mobile communication device based upon the user location.

FIG. 3 is a block diagram illustrating a wireless communication system associated with the present invention, and is suggested for printing on the first page of the issued patent.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as tools, modules, and/or managers. The functional units may be implemented in programmable hardware devices such as field programmable gate arrays, programmable array logic, programmable logic devices, or the like. The functional units may also be implemented in software for execution by various types of processors. An identified functional unit of executable code may, for instance, comprise one or more physical or logical blocks of computer instructions which may, for instance, be organized as an object, procedure, function, or other construct. Nevertheless, the executables of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

Current wireless communication technology support one or more secondary functions that are not necessarily related to conventional voice communication, including, but not limited to data communication. An example of one such function is a recording device within the mobile device. Most mobile telephones and/or smart phones include digital cameras that record still pictures or motion. It is not appropriate to take a mobile telephone into a private location where recording devices are specifically prohibited. Examples of private locations include, but are not limited to theaters, concerts, parties, etc. Accordingly, a method, system, and tool are provided to restrict operation of one or more functions of the mobile device based upon the physical location of the mobile device.

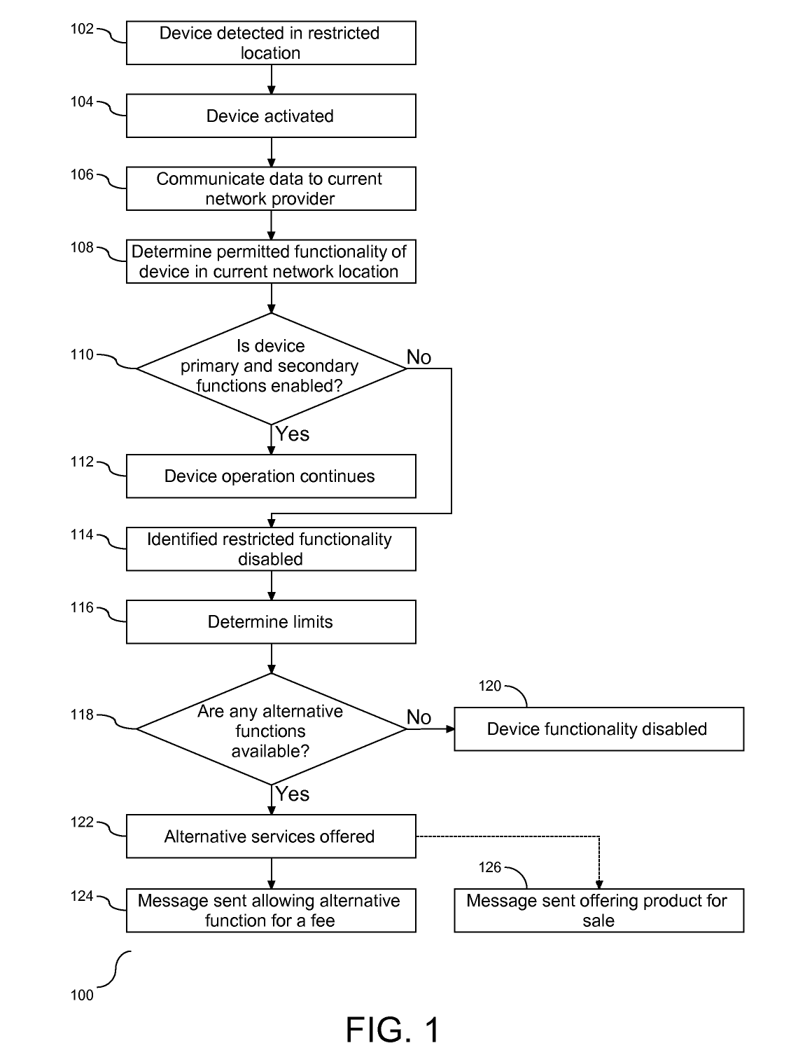

FIG. 1 is a flowchart (100) illustrating a process for restricting one or more functions of a mobile communication device, hereinafter referred to as a device, based upon the location of the device. The presence of the device is detected in a restricted location (102). In one embodiment, the restricted location does not embody visible one or more parameters; rather the restriction is based upon the device entering a private locale or communication network. While in the restricted location, a user activates the device or a specific function of the device (104). The activation of the device is followed by communication of data to the provider of the current network where the device is located (106). In one embodiment, the communication may be non-visible to a user. For example, the communication may be in the form of registration of the device in a foreign network. The data includes the global position coordinates of the device. In one embodiment, the global position coordinates are determined by using a global position transponder incorporated with the device. The purpose of ascertaining the global position coordinates of the device location is to cross reference them against a compilation of data to determine the permitted functionality of the device within the current network location (108). In one embodiment, the compilation of data includes a database of events. Following step (108), it is determined if the device is authorized for enablement of all of it's primary and secondary functions in its current location (110). In one embodiment, the determination at step (110) pertains to a match of the global coordinate data of the device with coordinates retained in the compilation of data. It is noted that storage media is consulted to determine if the functionality of the device is to be restricted in any form. In one embodiment, global position coordinates that identify the boundaries of the network are retained in the storage media and define the scope of the restriction boundaries. These global position coordinates may be registered with a network provider prior to or during the occurrence of an event. Similarly, in one embodiment, the service provider maintains or is in communication with storage media containing coordinate data pertaining to specific global position coordinates that restrict functionality of the device. For example, the storage media may contain global position coordinate entries related to multiple public events, with each event associated with an event profile. In this example, there may be one or more rules associated with one or more of the registered events with the rules defining functions to be restricted and/or a list of alternative services or functions to replace the restricted function. A positive response to the determination at step (110) is followed by continued operation of the device (112). However, if the response to the determination at step (110) is negative, an identified restricted functionality of the device is disabled (114). For example, in one embodiment, the restricted functionality of the device may include a recording function, including but not limited to still pictures, video, and sound. In another embodiment, it may be another function of the communication of the device that is disabled. Accordingly, the global coordinate data is leveraged to disable the functionality of the device.

Following the restriction on of the functionality at step (114), a set of rules associated with the matching entry is consulted to determine the limits placed by the custodian of the private locale (116). More specifically, once the functionality has been disabled, there is an opportunity to re-enable the functionality with one or more restrictions and/or controls. The ability to re-enable the functionality may be communicated to the user of the device in different forms, including but not limited to voice and data communication. Following step (116), it is determined if the local network location allows any alternative functions of the device to be enabled (118). A negative response to the determination at step (118) is followed by disabling the device functionality in the current network location (120). Conversely, a positive response to the determination at step (118) is followed by one or more alternative services to the disabled functions being offered to the user (122). In one embodiment, a message may be sent to the communication device by the provider with a description of the alternative services offered. For example, if the coordinates of the device are found to be coordinates for a registered event, a voice or text message is sent to the device allowing the functionality of the device to be enabled for a fee (124). In yet another embodiment, a voice or text message is generated and sent to the device offering a higher quality product for sale than an equivalent to a product that could potentially be produced by the disabled function (126). Accordingly, the options provided to the device at steps (124) and (126) enable the user of the device to obtain an equivalent product with control maintained by the locale.

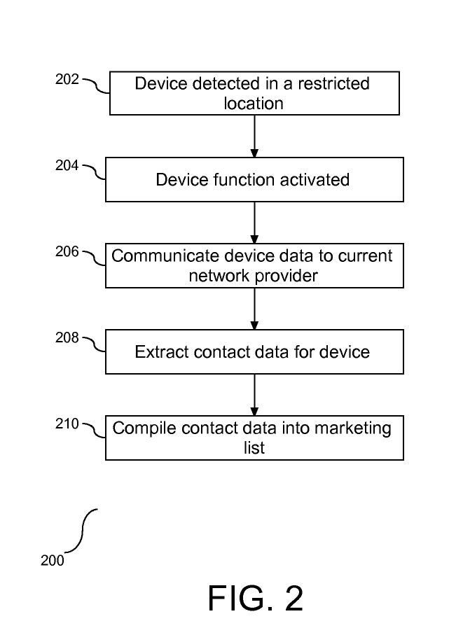

In one embodiment, an active sweep of all the devices at an event may be implemented and subsequently used to generate a list of attendees present at an event based upon the extracted ownership from each device. FIG. 2 is a flow chart (200) illustrating a process for compiling data from the devices. The presence of the device is detected in a restricted location (202). In one embodiment, the restricted location does not embody visible one or more parameters; rather the restriction is based upon the device entering a private locale, a private network, a foreign network, etc. While in the restricted location, a user activates a specific device or specific function of the device (204). The activation of the device and/or function of the device is followed by communication of data to the provider of the current network where the device is located (206). The data includes the global position coordinates of the device. In one embodiment, the global position coordinates are determined by using a global position transponder incorporated with the device. Similarly, in one embodiment the communicated data includes contact information for the proprietor of the device. For each detected device in the locale, a list of contact data is generated (208). More specifically, a list of all detected devices and their associated identifying data, including contact information, is extracted and compiled. This list may be used as a marketing list for a current or future marketing campaign (210). For example, in one embodiment if the device is present at a specific entertainment event, the marketing list may be used as a marketing tool for a future entertainment event. Regardless of the basis for the presence of the device, the data gathered may be leveraged for future use. As described above, the data pertaining to the device is ascertained in response to a detected presence in a network or activation of a function in the network. However, the invention should not be limited to that particular scenario. In one embodiment, a sweep of all active communication devices in a locale may be conducted to create a list of attendees in the locale. Accordingly, data may be gathered from one or more devices in a locale, wherein the gathered data may be employed to control present and future activities associated directly or indirectly with a device.

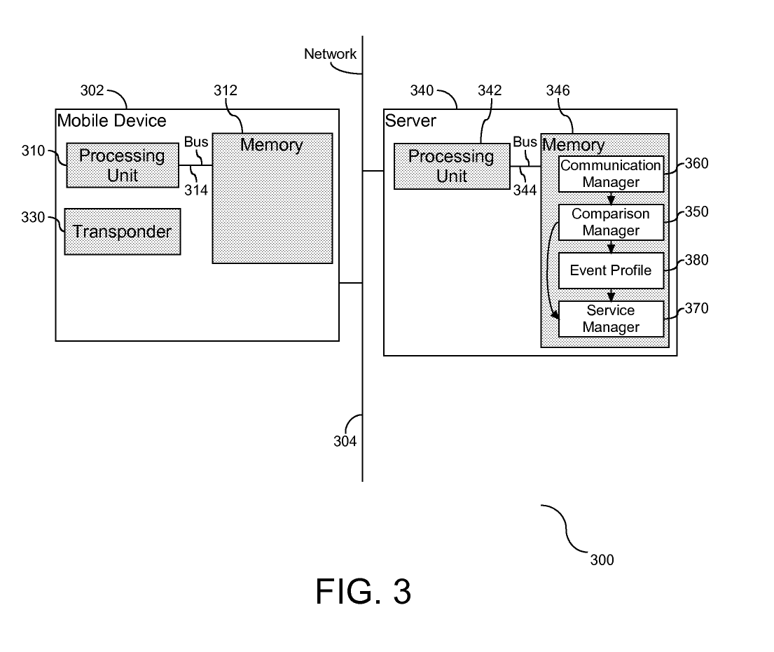

A system for managing restriction of one or more functions of a communication device based upon the user location associated with a public event, may involve the usage of one or more tools. FIG. 3 is a block diagram (300) illustrating a wireless communication system associated with the present invention. A device (302) is provided in communication with a server (340) across a network (304). The device (302) is provided with a processing unit (310) in communication with memory (312) across a bus (314). A transponder (330) is embedded within the device (302). In one embodiment, the transponder (330) is in the form of a transceiver that transmits a signal upon reception of a designated incoming signal. Similarly, in one embodiment, the transponder (330) is configured for global position data. A server (340) is provided with a processing unit (342) in communication with memory (346) across a bus (344). The server (340) is in communication with the device (302) over the network (304). Although both the device (302) and the server (340) are shown with a single processing unit, the invention should not be limited to this configuration. In one embodiment, the device (302) and/or the server (340) may be configured with multiple processing units. Accordingly, both the device (302) and the server (340) communicate over a shared network (304).

The server (340) is employed to support communication with the device (302). In one embodiment, a communication manager (360) local to the server (340) or a tool in communication with the network (304) is employed to gather data pertaining to the device(s) (302). The gathered data is retained in storage media (306) and/or communicated to a provider in communication with the device (302). For example, in one embodiment the gathered data may include entries containing global coordinates for each of the devices registered with the provider during a time interval and/or during a scheduled event at the locale. More specifically, when activation of the functionality is requested, the device may be at location (a, b) and it is determined if location (a, b) is contained within a region bounded by (x₁, y₁), (x₂, y₂), (x₃, y₃), and (x₄, y₄). Even if the location (a, b) is contained within these bounds, the function may be allowed depending upon a reserved time interval. With respect to a scheduled event, the server (340) may be provided with a comparison manager (350) directed to compare the coordinates gathered by the communication manager (360) with data pertaining to a locale designated for restricted functionality of the device (302). As noted above, certain functions associated with the communication device, such as audio and video recording, taking images, etc., may be designated to have restricted functionality at such time as the event takes place. In one embodiment, an event profile (380) is created for each locale, with the event profile functioning as a tool detailing functions of the device(s) (302) subject to restriction for a specified event, data, time, etc. With respect to the communication manager (360) and/or the event profile (380), a service manager (370) is provided in communication with the comparison manager (350) and is configured as a tool to both enforce the restriction of services as designated, and in one embodiment, to offer one or more alternative services supported by the device.

Similarly, in one embodiment, the communication manager (360) may be configured to gather information pertaining to each device (302) in the network (304) or in a locale, such as sweeping the locale to gather data to identify each of the devices in the locale (302). The service manager (370) may then leverage the gathered data to generate a list of attendees. In one embodiment, the generated list can be employed as a marketing list or tool. Accordingly, the data gathered by the communication manager (360) may be employed for various functions to generate value to the proprietor of the locale.

As shown herein, the comparison manager (350), the communication manager (360), the service manager (370), and the event profile (380) each reside in memory (346) local to the server (340). In one embodiment, the comparison manager (350), the communication manager (360), the service manager (370), and the event profile (380) may each reside as hardware tools external to memory (346), or they may be implemented as a combination of hardware and software. Similarly, in one embodiment, the comparison manager (350), the communication manager (360), and the service manager (370), and the event profile (380) may be combined into a single functional item that incorporate the functionality of the separate items. Furthermore, as shown herein, each of the comparison manager (350), the communication manager (360), the service manager (370), and the event profile (380) are local to one system (300). However, in one embodiment, they may be collectively or individually distributed across a network and function as a unit to embody the functionality of individual units. Accordingly, the comparison manager (350), the communication manager (360), the service manager (370), and the event profile (380) may be implemented as software tools, hardware tools, or a combination of software and hardware tools for managing the functionality of the planner in a distributed manner.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device). Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-usable or computer-readable medium providing program code for use by or in connection with a computer or any instruction execution system.

We claim:

1. A method of controlling a wireless communication device comprising:
responsive to activating at least one function of the device, determining global position coordinates of the device by using a global positioning system incorporated within the device;
communicating said coordinates to a provider in communication with said device;
said provider comparing said coordinates with data retained in storage media;
offering alternative services provided by said at least one function of the device responsive to said coordinates matching the data while the operation of said at least one function is restricted.

2. The method of claim 1, further comprising allowing operation of at least one function responsive to an element selected from the group consisting of: said coordinates not matching the data in the storage media, and said coordinates matching the data in the storage media and outside of a reserved time interval.

3. The method of claim 1, wherein the data is maintained by the provider.

4. The method of claim 1, wherein said data structure includes global position coordinate entries related to multiple public events, each event associated with an event profile including rule settings defining functions to be restricted and a list of alternative services for the restricted functions.

5. The method of claim 5, wherein global position coordinates of a public event is registered with the provider prior to the public event.

6. The method of claim 5, further comprising extracting ownership data of the communication device and compiling a list of attendees present at a public event based upon the extracted ownership from each communication device.

7. A system for controlling functionality of a wireless communication device comprising:
a global positioning transponder incorporated within the device to determine global position coordinates of the device responsive to activation of at least one function of the device;
a communication manager to communicate said device coordinates to a provider in communication with said device;
a comparison manager local to a server managed by the provider, the comparison manager to compare said coordinates with data retained in storage media;
a service manager to offer alternative services supported by said device responsive to a match of said coordinates to the data, while the operation of said at least one function is restricted.

8. The system of claim 7, further comprising the service manager to allow operation of at least one function responsive to an element selected from the group consisting of: said coordinates not matching the data in the storage media, and said coordinates matching the data in the storage media and outside of a reserved time interval.

9. The system of claim 7, wherein the data is maintained by the provider.

10. The system of claim 7, wherein said data includes global position coordinate entries related to multiple public events, each event associated with an event profile including rule settings defining functions to be restricted and a list of alternative services for the restricted functions.

11. The system of claim 7, wherein global position coordinates of a public event is registered with the provider prior to the public event.

12. The system of claim 7, further comprising a director to extract ownership data of the communication device and to compile a list of attendees present at a public event based upon the extracted ownership from each communication device.

13. An article to communicate with a wireless communication device comprising:
a computer readable data storage medium and instructions in the medium to control at least one function of the communication device, the instructions comprising;
instructions to determine global position coordinates of the device responsive to activation of at least one function of the device;
instructions to communicate said coordinates to a provider in communication with said device;
instructions to compare said coordinates with data in storage media in communication with said provider;
instructions to offer services alternative to services provided by said at least one function of the device responsive to said coordinates matching the data while the operation of said at least one function is restricted.

14. The article of claim 13, further comprising allowing operation of at least one function responsive to an element selected from the group consisting of: said coordinates not matching the data in the storage media, and said coordinates matching the data in the storage media and outside of a reserved time interval.

15. The article of claim 13, wherein the data is maintained by the provider.

16. The article of claim 13, wherein said data structure includes global position coordinate entries related to multiple public events, each event associated with an event profile including rule settings defining functions to be restricted and a list of alternative services for the restricted functions.

17. The article of claim 13, wherein global position coordinates of a public event is registered with the provider prior to the public event.

18. The article of claim 13, further comprising extracting ownership data of the communication device and compiling a list of attendees present at a public event based upon the extracted ownership from each communication device.
